(19) United States
(12) Patent Application Publication
(10) Pub. No.: US 2006/0132558 A1
(43) Pub. Date: Jun. 22, 2006

(54) Hydraulic resistor for ink supply system

(76) Inventor: Dirk Verdyck, Merksem (BE)

Correspondence Address: AGFA CORPORATION;LAW & PATENT DEPARTMENT, 200 BALLARDVALE STREET, WILMINGTON, MA, 01887, US

(21) Appl. No.: 11/301,987

(22) Filed: Dec. 13, 2005

Related U.S. Application Data
(60) Provisional application No. 60/648,021, filed on Jan. 28, 2005.

(30) Foreign Application Priority Data
Dec. 21, 2004 (EP) EP04106780.2

(51) Int. Cl. B41J 2/175

(52) U.S. Cl. 347/85

(57) ABSTRACT

A hydraulic resistor for counteracting pressure pulses in an ink supply system of an shuttling inkjet printing system has a variable resistance, dependent upon mass-flow rate during low inkflows and during pressure transients having high ink flows. At least two ink channels are provided of which only one is relevant at high flow rates.

The application claims the benefit of U.S. Provisional Application No. 60/648,021 filed Jan. 28, 2005.

### FIELD OF THE INVENTION

The present invention relates to a buffer for counteracting pressure pulses in a fluid supply system.

More specifically the invention is related to a buffer system in an ink supply system of a inkjet printing system.

### BACKGROUND OF THE INVENTION

A lot of modern inkjet printing systems use a printhead, having an array of registrations nozzles, which move over the receiving medium, e.g. paper while the receiving medium is fed forward. The image is recorded by successively recording different bands of the image using the printhead which shuttles over the paper. Small volume printers used at home or at the office carry the ink supply cartridge on the same shuttle as the printhead or even use integrated cartridges containing the printing elements.

Large volume printers and industrial inkjet printers use a shuttling printhead mounted on a shuttling frame being subject to periodic or transient accelerations and deceleration.

The printhead is coupled to an ink supply which is mounted on a fixed body, being at standstill or possibly being subjected to different accelerations and decelerations.

The connection between the ink supply and the inkjet printhead is made by a tubing system, being partly flexible, to allow a connection between moving parts. The printhead can thus be supplied by a continuous flow of ink during printing.

Due to the accelerations/decelerations, pressure pulses will be generated inside the tubing system.

This was studied in detail but the fundamental equations for this pressure pulses can be summarised in the following differential equation:

$$Equation 1 \text{:}$$

$$\frac{\partial {p}_{accel}}{\partial x} = ρ \frac{{\partial }^{2} s}{\partial {t}^{2}} ,$$

with:

P_{accel}: pressure produced by the acceleration pulse at position x.

s: co-ordinate describing the position of the fluid particles.

ρ: density of the fluid.

Another excitation force for the fluid is the Brazier effect.

Mostly, as we deal with flexible tubing, which can bend in order to allow the relative motion of one part of the structure with regard to another part. When a tube bend, its cross section will change. This change of cross-section has 2 effects:
1) the area of its cross section will change, compressing or expanding the fluid contained in that cross-section.
2) The cross-sectional stiffness will change, altering the capacitance of the tube and therefore, giving a different speed of sound in that part of the tube.

When due to the movement, a global volume change appears in the tubing, pressure pulses will be generated and will be found a the printhead. Normally, these pressure pulses are of a kind of being low-frequent. Acceleration pulses tend to give a high-frequency pressure excitation.

The fundamental problems we are dealing with are in fact pressure waves or sound waves, that travel through the in fluid in the tubing towards the printhead. The propagation of these pressure pulses in our tubing can mathematically be described by transmission line theory.

An elementary part dx of the transmission line will exhibit:

(1) resistance (due to viscosity and material damping in the tube part)

(2) inductance (due to inertial effects, as a mass of fluid is moving)

(3) capacitance (due to storage of energy because of compressibility of the fluid and compressibility of the tube cross-sectional area). A description of the calculation of the transmission line parameters can be made.

The ink has itself also has acoustic properties, which can be modelled in detail as well.

This eventually leads to a global equivalent acoustic system, for every mechanical layout of the tubing and printing system, a similar (but different) equivalent system can be constructed.

In this equivalent circuit, the Brazier effect has not been modelled. Normally, this effect is very complex and although, being present in a real tubing system, modelling is best done by making appropriate measurements and inserting the Brazier pressure as a voltage source in the model. Furthermore, by selecting appropriate tubing material and giving a good guidance to the tubing, this effect can be minimized.

The Printhead Nozzle Meniscus.

The real focus of all the problems is the meniscus. The meniscus of the ink in the nozzle can be seen as a flexible membrane, that, unfortunately, can only sustain a certain pressure in the ink. When the pressure reaches a critical pressure p_{c}, given by the Laplace-Young equation:

$$Equation 2 \text{:}$$

$${p}_{c} = \frac{σ}{2 {R}_{nozzle}} [ Pa ] ,$$

Then the meniscus will break and this can have 2 effects:
(1) for a negative pressure, air bubbles will be suck into the active ink chamber and this will prevent the normal operation of that nozzle. Due to the bubbles the jetting performance of the nozzle is lost and this can only be fixed by an appropriate purging step. Negative pressure pulses, drawing the meniscus inwards into the nozzle channel are very destructive for the reliable jetting process of that nozzle and must be prevented in all cases. Also, when one channel falls out, in a printhead having a sheared wall technology, the other neighbouring channels also will show jetting difficulties, as the acoustic properties of this channel is changed due to air bubbles at the inside.
(2) For a positive pressure, extra ink droplets might be ejected towards the paper (receiver) or the neighbouring region of the nozzle plate might be contaminated with ink, giving pooling effects on the nozzle plate itself. Although, the meniscus is broken in the outward direction, it is not so lethal to the jetting process as a negative pressure pulse. Mostly, the nozzle will recover from this short pooling effect, but of course, excessive pressure pulses eventually can give irrecoverable pooling so that wiping of the nozzle plate will be necessary.

Therefore, in practice, pressure pulses at the entrance of the printhead, which will lead to pressure pulses in the nozzle, exceeding in magnitude p_{c}, must be prevented. Otherwise, it is not possible to print in a reliable way.

An example of pressure pulses, measured before a real printhead can be found in FIG. 1. Measured pressure before a printhead (black curve) and the magenta line giving the pressure limit for the negative pressure, which, as we can see, is violated 3 times for a scanning cycle of the printheads.

This can be avoided by placing an acoustic filter in the ink supply system to diminish these effective pressure pulses. Mostly, this is done by an “RC-filter” or lowpass filter.

Most manufacturers use such a filter or buffer to damp out the acoustic disturbances in the ink tubing.

A buffer consists mostly out of a hydraulic resistance at the input (resistor) and then a membrane (capacitor) to equilibrate pressure disturbances. An example of a lumped parameter equivalent circuit for such a buffer can be found in FIG. 2.

In practice, the capacitor C has a value that is determined by the properties of the membrane and the surface of the membrane. In practice, due to construction details, one wants to keep this membrane as small as possible. But, in order to have a low time constant of the filter, the resistance should be taken then as large as possible, as this will make the time constant RC large. The larger R, the better filtering properties and the better the high pressure peaks ink the ink supply will be flattened at the output.

Unfortunately, when the input resistance is high, due to normal printing operation, a pressure drop will occur being equal to the resistance multiplied with the amount of ink flowing to the printhead. The pressure drop will be a function of the image information and therefore, when printing variable image information, will give a variable pressure drop over the resistor. In practice, this pressure drop is limited, as the working range of the printhead is mostly, for a certain kind of ink, defined to be within certain boundaries. When the resistance R is to high, one might exceed this pressure range and this might lead to unreliable printing. This means e.g. that when printing a solid area having a high optical density the ink-flow to the head must be high. Due to the high resistance of the hydraulic buffer, it is possible that not enough ink can pass through the buffer and insufficient ink is jetted on the receiver.

Two desirable properties of a buffer contradict each other:
(1) R should be as large as possible to have good filtering properties.
(2) R should be as small as possible to have a low pressure drop during normal printing operation.

Furthermore, when having a pressure transient at the entrance of the buffer, this will give a certain pressure transient at the output of this buffer. Of course, the amplitude of this pressure pulse should not exceed the p_{c} of the head (otherwise, the meniscus will break), but also, the transient should be as small as possible, as to reach as fast as possible a pressure before the head that is close to the normal operating condition:

(1) the larger R, the better the pressure is flattened, but the larger will last the transient.

(2) A small R will give a fast transient response and bring the pressure fast close to the normal printing conditions, but the pressure peaks might be close to p_{c}.

RC-buffers tend to be in use in most inkjet printers but a thorough analysis shows that the properties of such a RC filter are certainly not optimised due too pressure drop during normal printing operation and the transient response due to acceleration pulses in the tubing.

The current state of the art buffers all use linear resistors. And with linear is meant a resistor that stays constant in value.

There is clearly a need for an ink buffer capable of suppressing transient pressure pulses and at the same time allowing a high ink flow during printing of e.g. a solid full colour area.

### SUMMARY OF THE INVENTION

The above-mentioned advantageous effects are realised by a hydraulic resistor having the specific features set out in claim 1. Specific features for preferred embodiments of the invention are set out in the dependent claims.

Further advantages and embodiments of the present invention will become apparent from the following description and drawings.

### BRIEF DESCRIPTION OF THE DRAWINGS

FIG. 1 shows the pressure measured at a real printhead during a shuttling sequence.

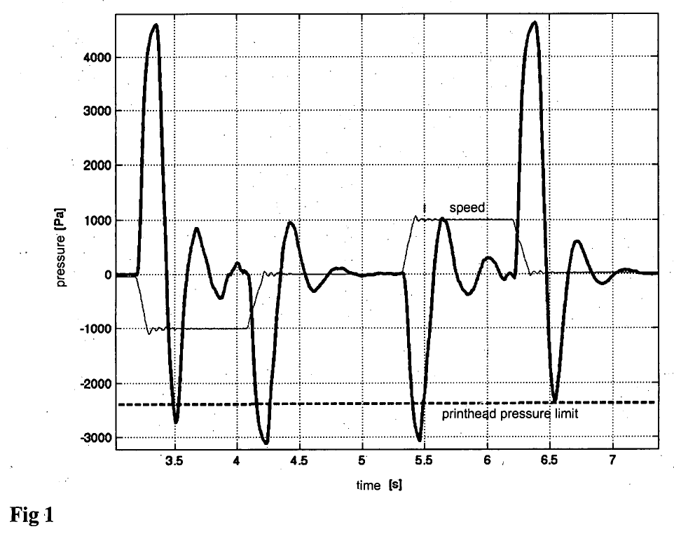

FIG. 2 shows the lumped parameter model equivalent of a hydraulic buffer.

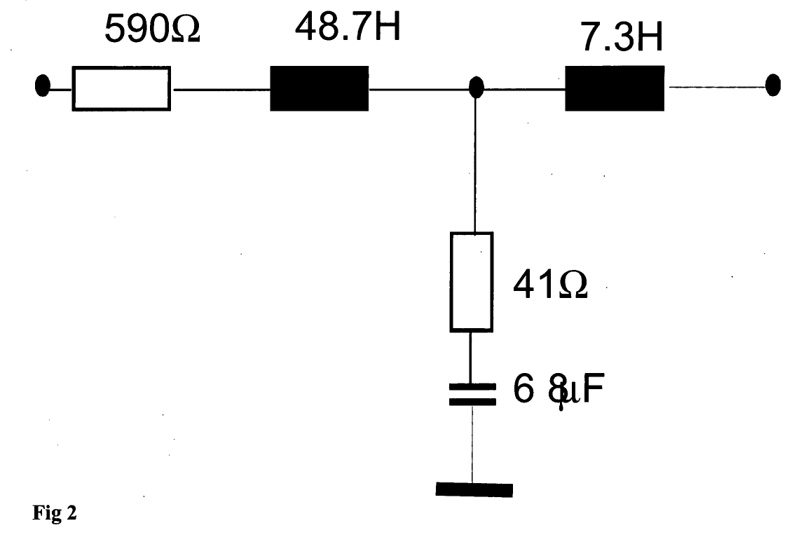

FIG. 3 depicts a possible resistor according to the present invention.

FIG. 4 illustrate the ink flow rates pattern at low ink take-off during normal operation.

FIG. 5 gives the ink flow rate pattern during a transient pressure pulse

FIG. 5b Geometry used in the dimensionless simulation of the flow of the fluid in a vortex structure.

FIG. 6 shows the calculated ratio p′/u′ in the dimensionless space for a range of the dimensionless input velocity u′.

FIG. 7 Transient response of a buffer having a non-linear resistor compared to a buffer having a linear resistor.

FIG. 8 Practical implementation of a resistor to be used in a commercial buffer. The resistor consists of a series combination of several non-linear resistors.

FIG. 9 Theoretical resistance of a non-linear resistor, calculated with finite element code and the resistance obtained by performing an experimental measurement of flow-rate and pressure drop.

FIG. 10 Transient pressure measured before the buffer and after the buffer in a real inkjet printer with scanning printhead.

FIG. 11A shows a non-circular embodiment of an hydraulic resistor. FIG. 11B shows a possible hydraulic resistor having more than two flow-channels.

### NOMENCLATURE

p: pressure drop over the buffer

\overline{u}: mean velocity of the fluid calculated over a certain cross-section

R: electrical resistance of a resistor that is equivalent to the pressure drop over the buffer

v: electrical voltage over the equivalent circuit of the buffer, representing the properties of the hydraulic buffer

ρ: density of the ink or fluid

μ: viscosity of the ink or fluid

S₀: cross-sectional area of a hydraulic component at a certain place and the total fluid passing this area represents the total mass flow through this component.

i: electrical current, being the equivalent of the hydraulic mass flow.

R₀: a constant representing a certain resistance offset value, unit [Ω].

k_{R}: a constant representing the proportionality of a resistance with regard to the mass flow i, independent of the sign of this mass flow.

P′: dimensionless pressure, used for making material independent calculations.

U′: dimensionless fluid velocity, used for making material independent calculations.

t: time [s]

t′: dimensionless time [ ]

p_{c}: capillary pressure under a meniscus

R_{c}: capillary radius of the meniscus

σ: surface tension of the ink or fluid.

### DETAILED DESCRIPTION OF THE PREFERRED EMBODIMENTS

For calculational purposes, it is sometimes interesting to translate the hydraulic parameters like pressure and mass flow rate, into electric quantities. In practice, a complex hydraulic circuit consisting of hydraulic resistances, membranes and tubing can be translated into an electrical circuit equivalent consisting of resistors, inductances, transmission lines and capacitances. Transient calculations can then easily be performed in a circuit simulator like e.g. Spice and the resulting solution can be translated back into hydraulic quantities.

In the detailed description of this invention, the properties of the non-linear hydraulic resistance will be described in the electrical domain, where as it's ohmic resistance will correspond to a corresponding hydraulic resistance. For this transformation, the following similarities will be used.

First, a similarity between hydraulic pressure and electrical voltage is put forward by the following expression:

$$Equation 3 \text{:}$$

$$v = \frac{p}{ρ} [ V ] ↔ [ \frac{{m}^{2}}{{s}^{2}} ] ,$$

With p the hydraulic pressure [Pa] and ρ the density of the fluid [kg/m³]

Another similarity can be found between electrical current and total hydraulic mass flow in the section of the tube or hydraulic circuit element:

$$Equation 4 \text{:}$$

$$i = {S}_{0} ρ \cdot \overline{u} [ A ] ↔ [ \frac{kg}{s} ] ,$$

With S₀ the section of the hydraulic component, ρ the density of the fluid and \overline{u} the mean flow-rate velocity over the section S₀.

It can be proven that in this electric to hydraulic similarity, energy and power losses are transformed correctly.

The electric resistance of a component is defined as the voltage drop over the component divided by the current. With the above hydraulic similarities, it can be found that:

$$Equation 5 \text{:}$$

$$R = \frac{v}{i} = \frac{p}{{ρ}^{2} \overline{u} {S}_{0}} [ Ω ] ↔ [ \frac{{m}^{2}}{kg} ] .$$

In hydraulics, it is not commonly used to express the hydraulic resistance in the above form, but the above form allows Joule's equation to be used, which defines the losses as Ri², which gives pS₀\overline{u} [W] in the hydraulic domain and which represents the work done by the pressure when having a pressure drop p over a component with a volumetric flow-rate S₀\overline{u}.

A more common expression for hydraulic resistance might be the pressure drop divided by the volumetric flow rate

$${R}_{hydraulic} = \frac{p}{{ρ }_{0} S} ,$$

but this quantity can easily found from an electric resistance expression by the following transformation:
R_{hydraulic}=R_{electric}·ρ² Equation 6:

A new design according to this invention is characterised in that the ink flow resistance of the hydraulic resistor is low during normal printing operation and high during pressure transients. This is possible by developing a resistor that shows a linear increase of the resistance as a function of the mass flow rate through this resistor. In the equivalent electrical domain, this can be expressed as:
R(i)=R₀+k_{R}|i|[Ω]. Equation 7:

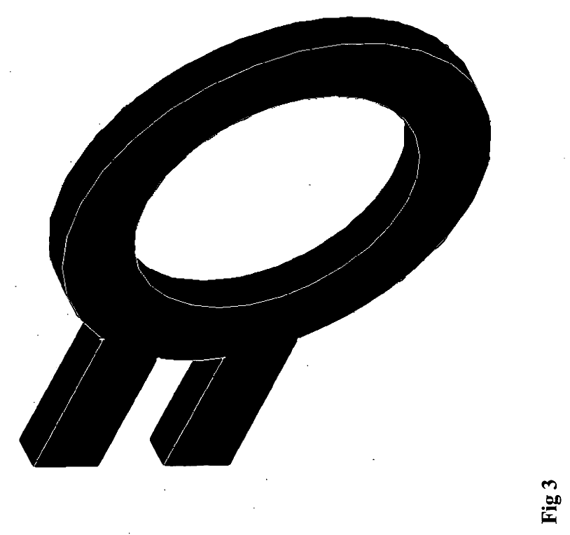

FIG. 3 gives a possible basic geometry of the resistor which is the most essential part of the hydraulic buffer. The real buffer can comprise a series circuit of several such circuits:

The resistor consists of at least two components both having an effect on the combined total resistance of the resistor. However, the effect of one component on the combined resistance is only relevant at high flow rates.

The fact that a component has only influence on the combined resistance is caused by the specific geometrical design of the hydraulic buffer.

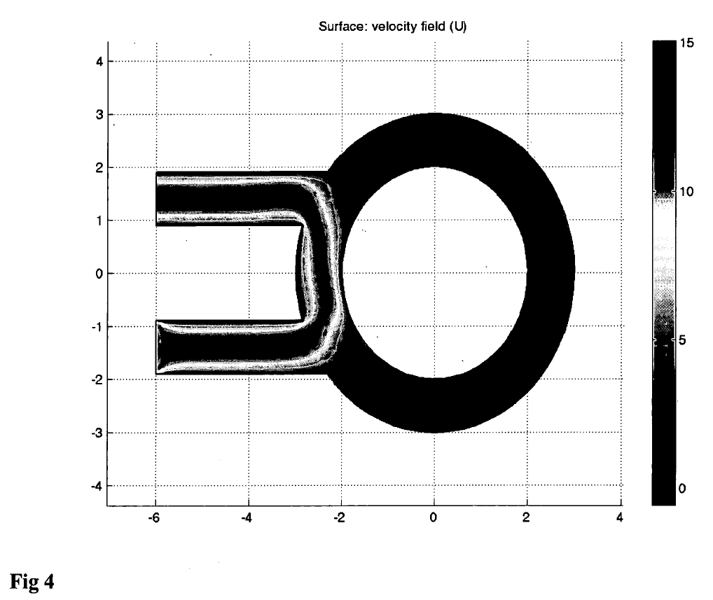

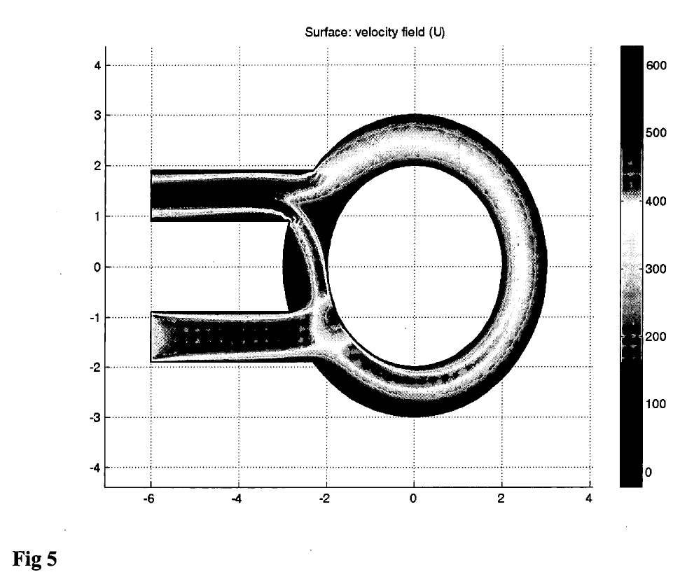

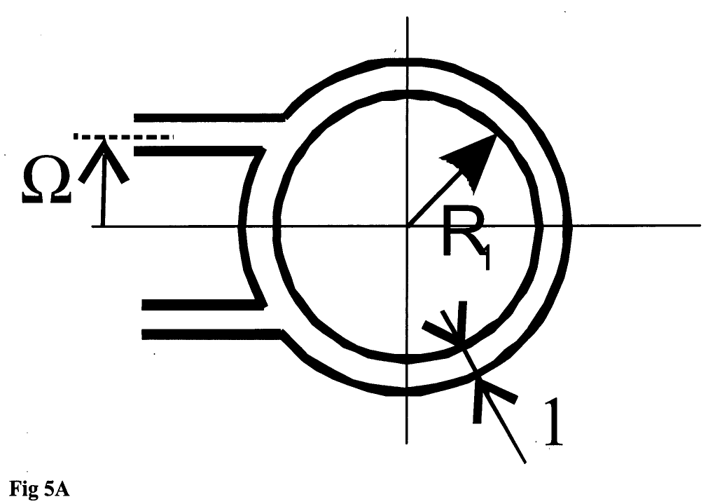

The working of such a buffer is illustrated by FIGS. 4 and 5. The buffer has two ink-flow channels each forming a component of the resistor and one of said channels, in casu the longer channel is the component having only a limited effect on the resistance during low flow rates.

At normal flow rates the fluid passage is illustrated by FIG. 4, the ink follows the short path and the resistance of the resistor is low. The long ring-like path barely plays a role in the ink flow through the buffer. The longest ink flow channel will have no or a negligible effect upon the total resistance of the hydraulic resistor.

When pressure transients occur the situation will be like in FIG. 5. A large part of the ink flow will pass along the ring-like channel and this will lead to increased losses in the flow. The mechanism is “activated” by the inertia of the ink guiding the ink into the second channel. It is due to the activation of the second component of the buffer and probably also caused by the interaction of the two different ink-flows that the resistance of the hydraulic resistor will increase substantially.

Of course, there are limits to this behaviour, as the flow will become turbulent and then a constant resistance will be achieved, independent of the fluid flow rate. However for rapid transient pressure pulses, it is normally not possible to build up a turbulent flow, as this needs time, and therefore, things are not that worse in practice.

A detailed theoretical discussion of this structure has been done. In a 2D calculation, an optimisation has been done with regard to some geometrical details of this structure. These calculations have been performed in a dimensionless form, as is usually done in hydraulic calculations. Therefore, the geometry, as depicted in FIG. 5b is considered. The width of the vortex channel is put equal to 1 meter and the inlet and outlet openings can be found at a height Ω. The vortex radius equals R.

With regard to a dimensionless analysis, the following reference variables will be used for defining the dimensionless units:

$$Equation 8 \text{:}$$

$$\{ \begin{matrix}{P}_{ref} = \frac{{μ}^{2}}{ρ {L}_{ref}^{2}} \\ {U}_{ref} = \frac{μ}{ρ {L}_{ref}} \\ {t}_{ref} = \frac{ρ}{μ} {L}_{ref}^{2}\end{matrix} . \\ By defining \text{:} \\ Equation 9 \text{:} \\ \{ \begin{matrix}{p}^{′} = \frac{p}{{P}_{ref}} \\ {u}^{′} = \frac{u}{{U}_{ref}} \\ {t}^{′} = \frac{t}{{t}_{ref}}\end{matrix} ,$$

The vortex flow can be simulated for random fluid properties and the results of this calculation can be recalculated to the real physical values by using the definitions in the above 2 equations.

For the geometry of FIG. 5B, with Finite element (FEM) calculations, it is shown that

the ratio of p′/u′ rises linearly with u′

Wherein u′ is the dimensionless input ink velocity and

P′ is the dimensionless pressure at the resistor's input.

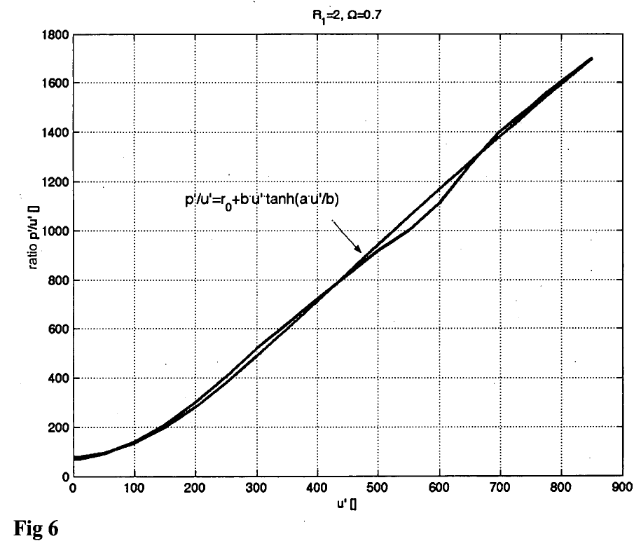

A example curve can be found in FIG. 6.

It turns out that the best linear resistance rise can be achieved by taking Ω as small as possible. In practice, limits will exists for Ω, due to the mechanical technology that will be used to construct the structure.

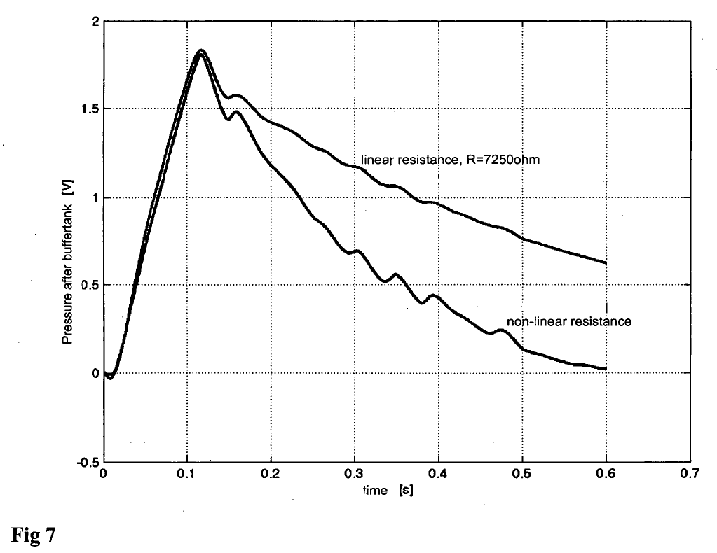

The benefits of such a resistance behaviour are:
(1) first of all, during normal operation, the flow-rate is low and therefore, the resulting resistance of the structure will be low as well.
(2) High pressure pulses will introduce a large flow and this will increase the resistance. The higher resistance will give a better RC-filtering.
(3) It turns out that the transient behaviour is better than in case a linear resistance is being used, as given in the graph of FIG. 7.

### Experimental Verification

For a water-glycerol mixture, the R-I characteristic has been determined using experimental means and this is compared with the theoretical calculation (in this case a 3D fem analysis):

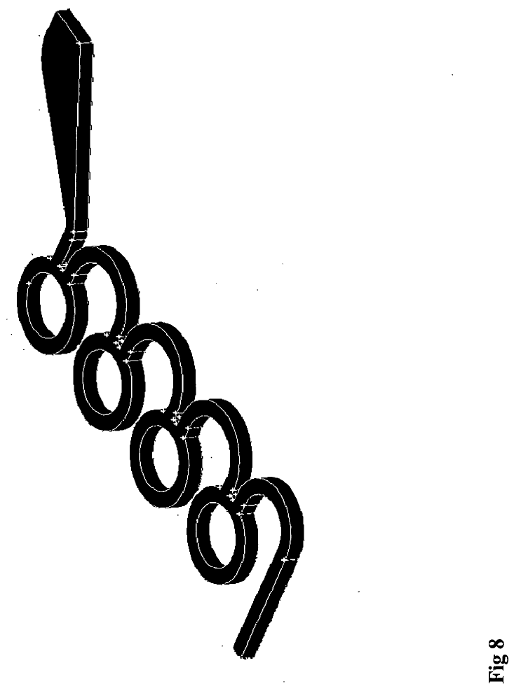

FIG. 8. gives the geometry that was subjected to the measurement and comprises a series situation of 4 vortexi.

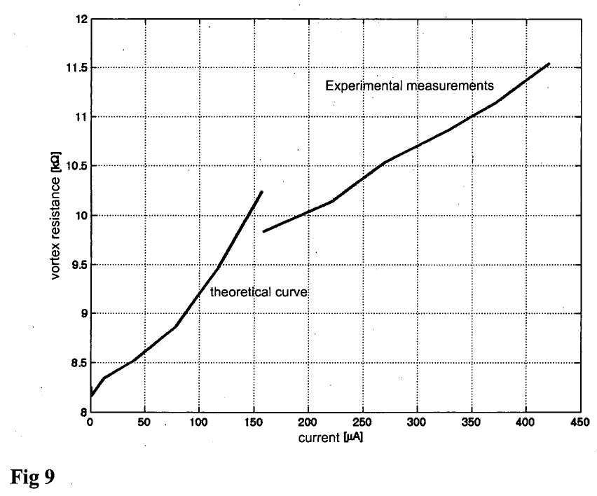

FIG. 9 gives the measurements of the experiment and shows indeed that the resistance increases with the mass-rate. Theoretical and measured curves form a nearly continuous line.

Fluid volume of a preferable design.

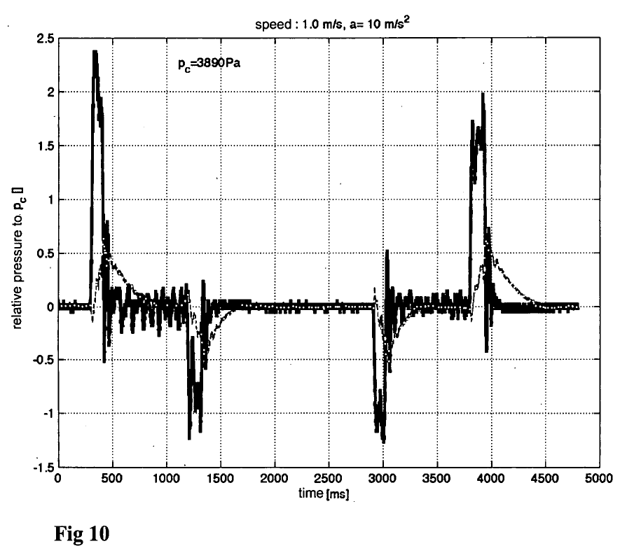

The transient response of a buffer equipped with this resistor in depicted in the FIG. 8 is given in FIG. 10.

The pressure has been calculated relative to the p_{c} of the nozzle. So, a pressure larger than 1 in magnitude can give problems to the meniscus stability.

In FIG. 10 measured pressure pulses (black) and corresponding transient response of the filter (red curve), taking during the movement of a scanning printhead, stroke=900 mm, speed: 1 m/s and acceleration: 10 m/s². The graph indicated that the buffer is capable of suppressing the pressure transients which would otherwise disturb the recording.

### Alternative Embodiments

Preferably the resistor has two components wherein the effect of at least one component on the total resistance is only relevant at high flow rates.

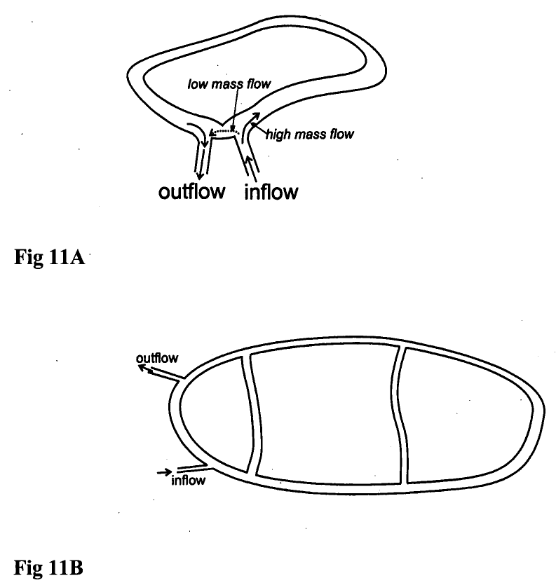

Normally this is achieved by having at least 2 different flow channels. The resistor of FIG. 3 has two channels but a resistor having more channels can be constructed. Several alternative embodiments can be constructed. The idea is to have a system with alternative flow channels where the flow in a certain channel is influenced by the kinetic energy that is present in the incoming channel or channels. Therefore, it is not mandatory to have e.g. a circular structure as used now in the embodiment of FIG. 3. Some possible different configuration is given in FIG. 11. Also, modifications can be made to the inlet and the outlet channels to give some predefined hydraulic flow pattern that can enhance the resistance difference between a low and a high mass flow regime. An example of this is given in FIG. 12, where some rounding is applied at the inflow and outflow channel, to deliberately force the fluid flow along the long path and therefore enhance a higher resistance at large mass flow but keeping a low resistance at very low mass flow.

FIG. 13. Gives a possible solution having more than 2 channels having a ring like structure. Even more complicated calculations are needed to simulate the behaviour during pressure transients, but non-linearity is likewise expected.

It is clear that the same variable resistance can not be obtained using resistors having moving parts because they can not react quickly enough to counteract the very short pressure transients. Therefore, a solution must be found in solid state resistors, preferable having no moving parts, as any moving part itself is able to generate unwanted pressure pulses in the system as well.

Also, such a ring-like structure can have a single inflow opening and several outflow openings, where one of the outflow openings can supply the print head where the other outflow opening can be used to set a global pressure in the system, e.g. to define the under pressure at the printhead nozzles.

Also, as shown in FIG. 8, several kind of ring-like structures can be put in series with each other, this with the purpose of generating a global filter behaviour, that is built up as a series connection of the filter responses of the several individual filter ring-like structures.

Alternative embodiments of the hydraulic resistor deviating from the circular geometry or having plural channels can be found in FIGS. 11A and 11B.

The buffer comprising the resistor can be positioned at different locations:

It can be positioned close to the printhead or can be even incorporated in the printhead.

More likely the buffer is located close by or in the header tank to absorb the pressure variations due to shuttling.

Having described in detail preferred embodiments of the current invention, it will now be apparent to those skilled in the art that numerous modifications can be made therein without departing from the scope of the invention as defined in the appending claims.

1. A hydraulic resistor, for counteracting pressure pulses, for an ink supply system of an inkjet printing system;
characterised in that the ink flow resistance of the resistor is low during normal printing operation and high during pressure transients.

2. The resistor according to claim 1 wherein the resistance is dependent upon mass-flow rate.

3. The resistor according to claim 2 having at least two components wherein the effect of at least one component on the total resistance is only relevant at high flow rates.

4. The resistor according to claim 3 wherein the effect of said component is triggered by an inertia effect.

5. The resistor according to claim 2 wherein the effect of said component is due to geometrical design.

6. The resistor according to claim 5 comprising at least 2 flow channels for allowing ink flow and wherein at least one flow channel is said component.

7. The resistor according to claim 6 wherein the effect is caused by at least 2 interacting ink-flows.

8. The resistor according to claim 6 wherein the flow channels form a ring-like structure.

9. The resistor according to claim 6 wherein the flow channels form an elongated structure.

10. The resistor according to claim 2 wherein the resistor is a solid-state resistor.

11. An inkjet printing system having a shuttling printhead comprising at least one transient buffer having at least one resistor according to claim 2.

12. Inkjet printing system according to claim 11 wherein at least one buffer is located close to or in the printhead.

13. Inkjet printing system according to claim 11 wherein at least one buffer is located close to or in header tank.
